(19) United States
(12) Patent Application Publication
(10) Pub. No.: US 2013/0017860 A1
(43) Pub. Date: Jan. 17, 2013

(54) RF Processing Device and RF Processing Method

(71) Applicant: Yung-Jinn Chen, New Taipei City (TW)

(72) Inventor: Yung-Jinn Chen, New Taipei City (TW)

(21) Appl. No.: 13/291,111

(22) Filed: Nov. 8, 2011

(30) Foreign Application Priority Data
Jul. 13, 2011 (TW) 100124774

(51) Int. Cl. H04W 88/02

(52) U.S. Cl. 455/556.1

(57) ABSTRACT

The present invention discloses a radio-frequency (RF) processing device for a mobile communication device. The RF processing device includes an antenna, an RF signal processing module, at least one proximity sensor for detecting an approaching status of an object corresponding to the RF processing device to generate a detection result, and a matching adjustment module for adjusting an impedance value between the antenna and the RF signal processing module according to the detection result, so as to decrease an influence on an RF signal of the mobile communication device caused by approaching of the object.

### BACKGROUND OF THE INVENTION

1. Field of the Invention

The present invention relates to an RF processing device and RF processing method for adjusting antenna matching to mitigate an influence of environment according to environment changing.

2. Description of the Prior Art

Due to the prosperous development of wireless communications in recent years, more and more information is transmitted through wireless networks and thus demand for wireless communications increases. Therefore, how to provide quality, stable wireless communication becomes one of the goals in the wireless technology industries.

For receiving wireless signals, an antenna of the mobile communication device induces and transfers radio waves into high frequency signals to transmit to an RF processing module. In order to reduce signal reflection and make the high frequency signal transmission to the RF processing module as efficient as possible, to achieve maximum output power of the antenna, there is a matching circuit disposed between the antenna and the RF processing module for making a characteristic impedance of the RF processing module equal a loading impedance of the antenna. However, electronic parameters of the matching circuit are usually determined by the manufacturer. In other words, once the electronic parameters are fixed, the desired impedance matching cannot be adjusted to correspond to different usage situations, which may lead to an influence on wireless signal transmission. For example, antenna performance, e.g. radiation pattern or efficiency, is different and may degrade when a user holds a mobile phone in their hands or puts the mobile phone on a metal desk. Thus, the matching requires adjustment.

According to above description, the conventional mobile communication device cannot adjust the impedance matching based on different usage situation, which may lead to an influence on wireless signal transmission. Therefore, there is a need to improve the prior art.

### SUMMARY OF THE INVENTION

It is therefore an object of the present invention to provide an RF processing device and RF processing method.

The present invention discloses a radio-frequency (RF) processing device for a mobile communication device, including an antenna, an RF signal processing module, at least one proximity sensor for detecting an approaching status of an object corresponding to the RF processing device to generate a detection result, and a matching adjustment module for adjusting an impedance value between the antenna and the RF signal processing module according to the detection result.

The present invention further discloses a radio-frequency (RF) processing method for a mobile communication device, including detecting an approaching status of an object corresponding to the mobile communication device to generate a detection result, and adjusting an impedance value between an antenna of the mobile communication device and an RF signal processing module according to the detection result.

The present invention further discloses a mobile communication device, including a base band processing module, a radio-frequency (RF) processing device, including an antenna, an RF signal processing module for transmitting signals outputted by the base band processing module via the antenna, or transmitting signals received by the antenna to the base band processing module, at least a proximity sensor for detecting an approaching status of an object corresponding to the mobile communication device to generate a detection result, and a matching adjustment module for adjusting an impedance value between the antenna and the RF signal processing module according to the detection result.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a mobile communication device according to an embodiment of the present invention.

FIG. 2 is a schematic diagram of the matching adjustment module according to an embodiment of the present invention.

FIG. 3 is a schematic diagram of the matching adjustment module according to an embodiment of the present invention.

FIG. 4 is a schematic diagram of an RF processing process according to an embodiment of the present invention.

FIG. 5 is a schematic diagram of an RF processing device with multiple antennas according to an embodiment of the present invention.

### DETAILED DESCRIPTION

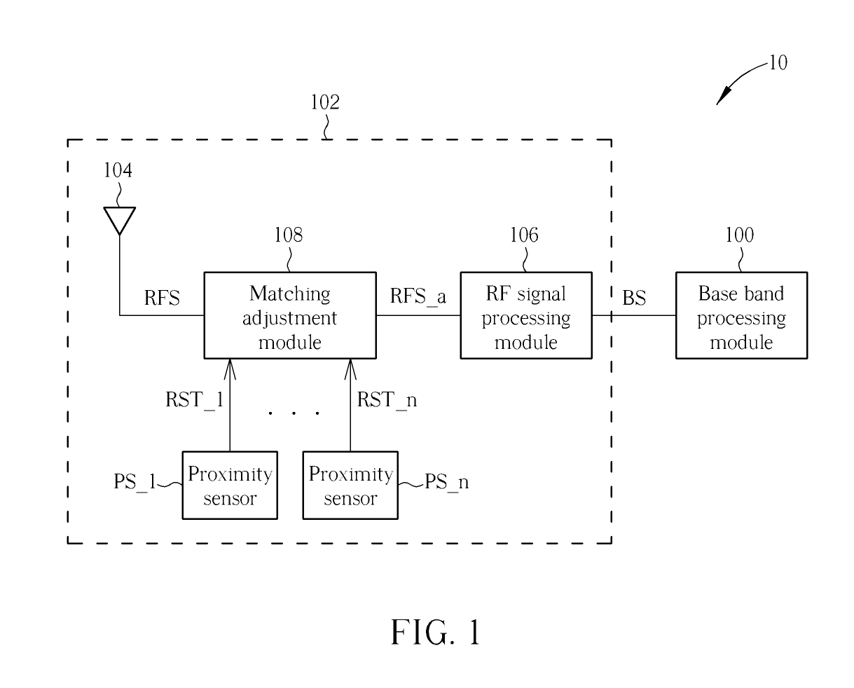

Please refer to FIG. 1, which is a schematic diagram of a mobile communication device 10 according to an embodiment of the present invention. The mobile communication device 10 may be a portable device, such as, inter alia, a mobile phone or a personal digital assistant (PDA). The mobile communication device 10 includes a base band processing module 100 and an RF processing device 102. The RF processing device 102 includes an antenna 104, an RF signal processing module 106, proximity sensors PS_1-PS_n and a matching adjustment module 108. The proximity sensors PS_1-PS_n may be infrared, sonic, capacitive, magnetic, or static electronics proximity sensors. The proximity sensors PS_1-PS_n are disposed at different positions inside a housing (not shown in FIG. 1) of the mobile communication device 10, for detecting an approaching status of an object outside the housing corresponding to the mobile communication device 10, so as to generate detection results RST_1-RST_n accordingly. The matching adjustment module 108 adjusts an impedance value between the antenna 104 and the RF signal processing module 106 according to the detection results RST_1-RST_n, and thus transfer an RF signal RFS received by the antenna 104 into an RF signal RFS_a, and then output the RF signal RFS_a to the RF signal processing module 106. The RF signal processing module 106 performs signal processing to the RF signal RFS_a, e.g. demodulation, decoding and frequency conversion, to output a corresponding base band signal BS to the base band processing module 100. The base band processing module 100 processes the base band signal BS to output image, data and/or voice, which realizes wireless communication functions.

In short, the mobile communication device 10 is capable of adjusting a matching, i.e. the impedance value, between the antenna 104 and the RF signal processing module 106 according to the approaching status of the object, e.g. user's head or hands, corresponding to the mobile communication device 10, which allows the mobile communication device 10 to adjust the matching to keep normal signal transmission under different usage situations.

Notably, the mobile communication device 10 shown in FIG. 1 is a feasible embodiment of the present invention, and is not limited. Modifications and alterations should be included as part of the present invention. For example, the number n of the proximity sensor PS_1-PS_n may be any number greater than or equal to 1 according to system requirements. Furthermore, there are only necessary elements shown in FIG. 1 to realize the present invention, and is not limited either. For example, the detection results RST_1-RST_n generated by the proximity sensor PS_1-PS_n may further output to the base band processing module 100, so that the base band processing module 100 may control turning a screen on/off, adjusting volume of a speaker and so on.

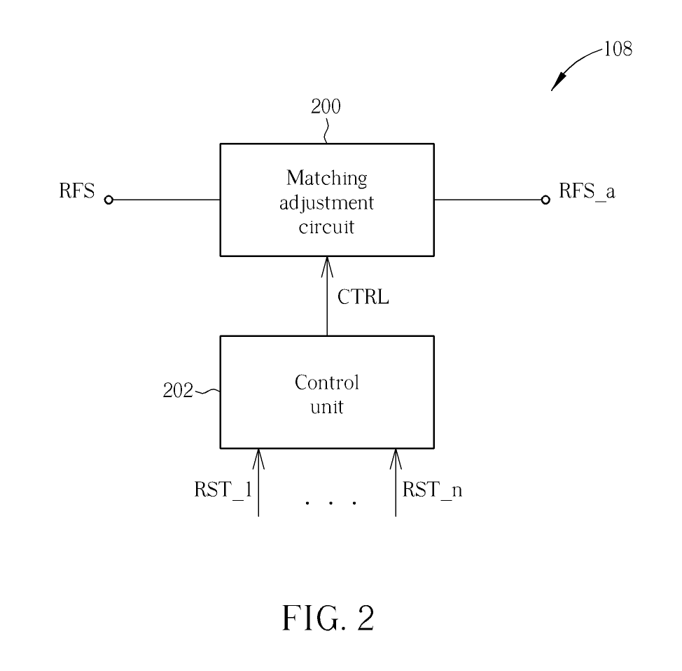

On the other hand, the matching adjustment module 108 is used for adjusting the matching between the antenna 104 and the RF signal processing module 106 according to the detection results RST_1-RST_n, however the matching adjustment module 108 may be realized through other ways. For example, please refer to FIG. 2, which is a schematic diagram of the matching adjustment module 108 according to an embodiment of the present invention. In FIG. 2, the matching adjustment module 108 includes a matching adjustment circuit 200 and a control unit 202. The control unit 202 generates a control signal CTRL to the matching adjustment circuit 200 according to the detection results RST_1-RST_n. The matching adjustment circuit 200 may comprise an adjustable capacitor, resistor and inductor. The matching adjustment circuit 200 adjusts the impedance value between the antenna 104 and the RF signal processing module 106 through changing electronic parameters, such as capacitance, resistance and inductance, according to the control signal CTRL. Thus, when an object approaches the housing of the mobile communication device 10, the control unit 202 determines the approaching status of the object, e.g. position and area, according to the detection results RST_1-RST_n, so as to output the control signal CTRL to the matching adjustment circuit 200, such that the impedance value between the antenna 104 and the RF signal processing module 106 is adjusted.

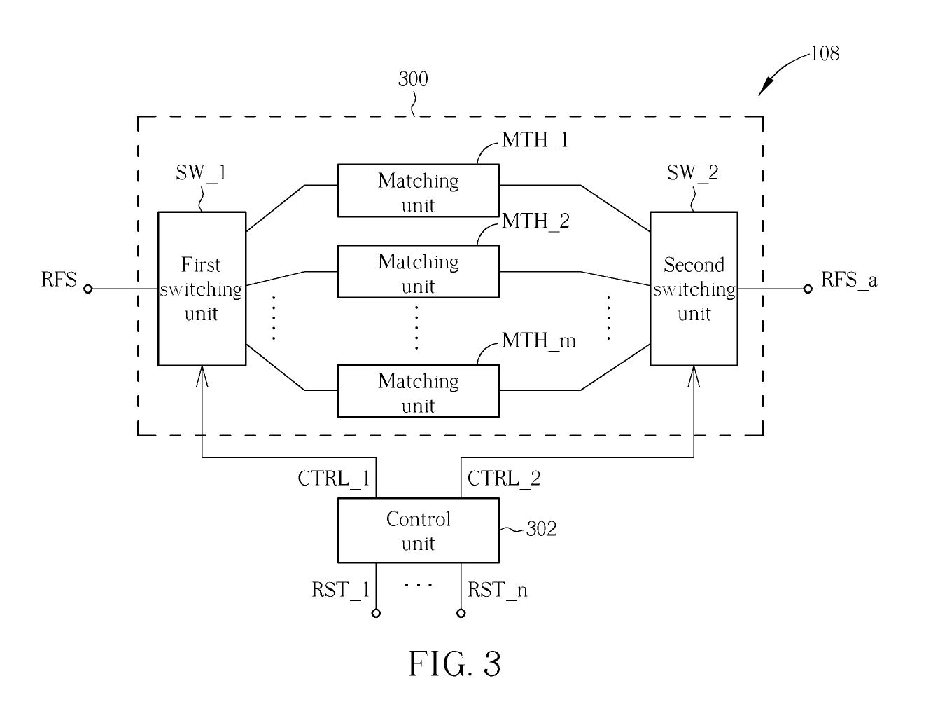

Besides, the matching adjustment circuit 200 may not be realized only through the adjustable capacitor, the adjustable resistor and the adjustable inductor, but also through multiple matching units corresponding to different impedance values. Please refer to FIG. 3, which is a schematic diagram of the matching adjustment module 108 according to an embodiment of the present invention. In FIG. 3, the matching adjustment module 108 includes a matching adjustment circuit 300 and a control unit 302. The control unit 302 generates control signals CTRL_1 and CTRL_2 to the matching adjustment circuit 300 according to the detection results RST_1-RST_n. The matching adjustment circuit 300 includes matching units MTH_1-MTH_m, a first switching unit SW_1 and a second switching unit SW_2. Each of the matching units MTH_1-MTH_m corresponds to an electronic parameter combination to have different impedance values. The first switching unit SW_1 is disposed between the antenna 104 and the matching units MTH_1-MTH_m, for switching the antenna 104 to connect with one of the matching units MTH_1-MTH_m according to the control signal CTRL_1. The second switching unit SW_2 is disposed between the matching units MTH_1-MTH_m and the RF signal processing module 106, for switching one of the matching units MTH_1-MTH_m to connect with the RF signal processing module 106 according to the control signal CTRL_2. Therefore, when an object approaches the housing of the mobile communication device 10, the control unit 302 determines the approaching status of the object according to the detection results RST_1-RST_n, and outputs the control signals CTRL_1 and CTRL_2 to the first switching unit SW_1 and the second switching unit SW_2, respectively. Then, the first switching unit SW_1 and the second switching unit SW_2 switch one of the matching units MTH_1-MTH_m to connect the antenna 104 and the RF signal processing module 106, so as to adjust the impedance value between the antenna 104 and the RF signal processing module 106.

The matching adjustment module 108 shown in FIG. 3 is realized through switching the matching units MTH_1-MTH_m between the antenna 104 and the RF signal processing module 106, so as to adjust the impedance value between the antenna 104 and the RF signal processing module 106. Those skilled in the art could make modifications and alterations accordingly, and the invention is not limited to the above description. For example, the control signals CTRL_1 and CTRL_2 may be a same control signal. The matching units MTH_1-MTH_m in the current disclosure illustrate a method of forming multiple impedance values by multiple independent electronic elements. Or, a same electronic element may form multiple impedances via different connecting combinations, controlling voltages and currents of the electronic elements. Furthermore, the control unit 302 in FIG. 3, or the control unit 202 in FIG. 2 may be additional units, but those may be realized by adding software/hardware functions in a microprocessor or a controller of the mobile communication device 10.

In the prior art, the traditional mobile communication device cannot adjust the matching based on different using situation, which may lead to an influence on wireless signal transmission. In comparison, in the present invention, when an object approaches the housing of the mobile communication device 10, the matching adjustment module 108 determines the position and area of the object according to the detection results RST_1-RST_n, so as to adjust the impedance value between the antenna 104 and the RF signal processing module 106, such that the efficiency of the antenna 104 stays in a proper range to ensure communication quality.

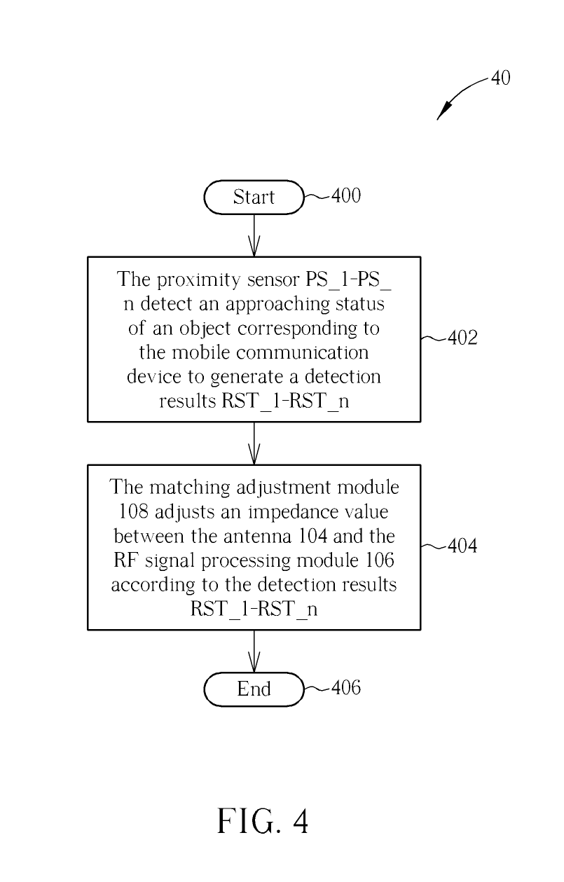

Operations of the RF processing device 102 can be further summarized into an RF processing process 40 shown in FIG. 4. The RF processing process 40 includes the following steps:

Step 400: Start.

Step 402: The proximity sensor PS_1-PS_n detect an approaching status of an object corresponding to the mobile communication device to generate a detection results RST_1-RST_n.

Step 404: The matching adjustment module 108 adjusts an impedance value between the antenna 104 and the RF signal processing module 106 according to the detection results RST_1-RST_n.

Step 406: End.

Details of the RF processing process 40 can be obtained by referring to above description, which are omitted here.

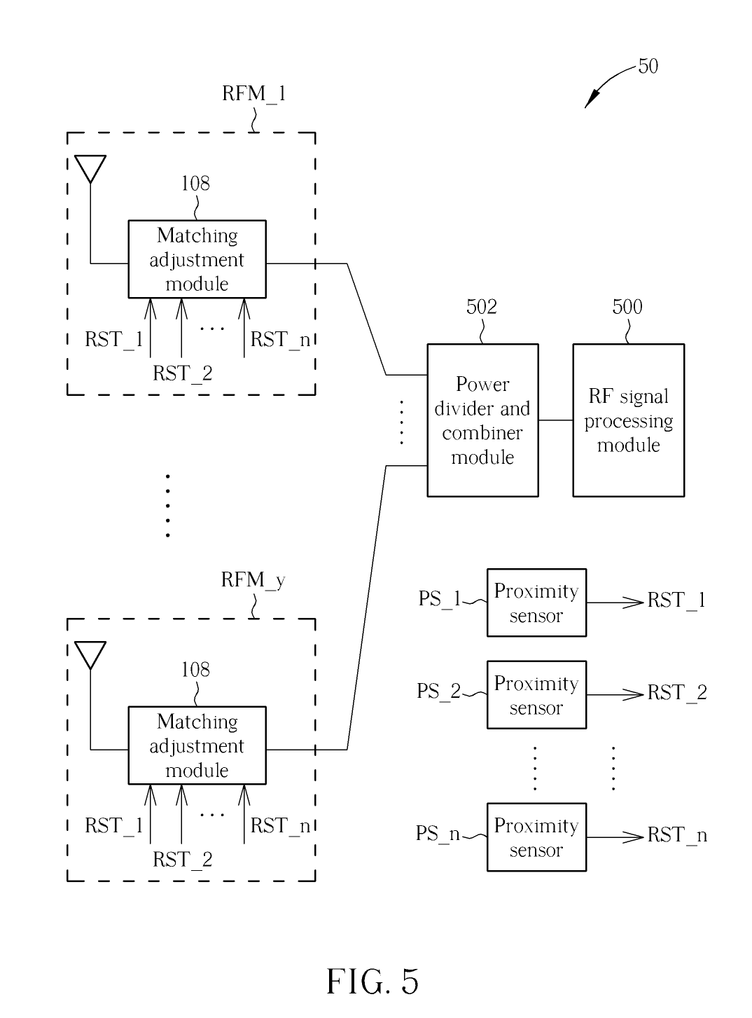

In addition, the above embodiment utilizes the mobile communication device with a single antenna to illustrate that the present invention adjusts the impedance value between the antenna and the RF signal processing module according to the approaching status of the outside object. However, the present invention is not limited to the mobile communication device with a single antenna. With a proper modification, a mobile communication device with multiple antennas is also feasible. For example, please refer to FIG. 5, which is a schematic diagram of an RF processing device 50 according to an embodiment of the present invention. The RF processing device is used for a mobile communication device, and includes RF sub-modules RFM_1-RFM_y, an RF signal processing module 500, a power divider and combiner module 502 and proximity sensors PS_1-PS_n. Each of the RF sub-modules RFM_1-RFM_y includes one antenna and one matching adjustment module, which are equivalent to the antenna 104 and the matching adjustment module 108 shown in FIG. 1.

Thus, comparing FIG. 5 with FIG. 1, the structure of the RF processing device 50 is similar to that of the RF processing device 102, and the difference is that the RF processing device 50 includes multiple antennas. For adapting to the multiple antennas structure, the RF processing device 50 further includes the power divider and combiner module 502. The power divider and combiner module 502 combines signals outputted from the RF sub-modules RFM_1-RFM_y to transmit the combined signal to the RF signal processing module 500, or divides the output signal outputted from the RF signal processing module 500 to transmit to the RF sub-modules RFM_1-RFM_y. Moreover, the matching adjustment modules of the RF sub-modules RFM_1-RFM_y adjust the matching between each of the multiple antennas to the power divider and combiner module 502 according to the detection results RST_1-RST_n outputted by the proximity sensor PS_1-PS_n. As a result, when an object approaches the housing of the mobile communication device, the RF processing device 50 determines the approaching status of the object according to the detection results RST_1-RST_n, so as to adjust the impedance values between each of the multiple antennas and the power divider and combiner module 502. In such a situation, the multiple antennas maintain better efficiency to ensure communication quality of the mobile communication device.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A radio-frequency (RF) processing device, for a mobile communication device, comprising:
an antenna;
an RF signal processing module;
at least one proximity sensor, for detecting an approaching status of an object corresponding to the RF processing device, to generate a detection result; and
a matching adjustment module, for adjusting an impedance value between the antenna and the RF signal processing module according to the detection result.

2. The RF processing device of claim 1, wherein the matching adjustment module comprises:
a matching adjustment circuit, coupled between the antenna and the RF signal processing module, for adjusting a plurality of electronic parameters according to a control signal to adjust the impedance value between the antenna and the RF signal processing module; and
a control unit, for generating the control signal according to the detection result.

3. The RF processing device of claim 2, wherein the matching adjustment circuit comprises:
a plurality of matching units, each matching unit corresponding to a combination of electronic parameters;
a first switching unit, coupled between the antenna and the plurality of matching units, for switching a connection between the antenna and one of the plurality of matching units according to the control signal; and
a second switching unit, coupled between the plurality of matching units and the RF signal processing module, for switching a connection between one of the plurality of matching units and the RF signal processing module according to the control signal.

4. The RF processing device of claim 1, wherein the RF signal processing module is an RF front-end circuit.

5. A radio-frequency (RF) processing method, for a mobile communication device, comprising:
detecting an approaching status of an object corresponding to the mobile communication device, to generate a detection result; and
adjusting an impedance value between an antenna of the mobile communication device and an RF signal processing module according to the detection result.

6. The RF processing method of claim 5, wherein the step of adjusting an impedance value between an antenna of the mobile communication device and an RF signal processing module according to the detection result comprises:
forming a plurality of electronic parameter combinations of the electronic parameters between the antenna and the RF signal processing module; and
selecting one of the plurality of electronic parameter combinations according to the detection result, to adjust the impedance value.

7. A mobile communication device, comprising:
a baseband processing module;
a radio-frequency (RF) processing device, comprising:
an antenna;
an RF signal processing module, for transmitting signals outputted by the baseband processing module via the antenna, or transmitting signals received by the antenna to the baseband processing module;
at least a proximity sensor, for detecting an approaching status of an object corresponding to the mobile communication device, to generate a detection result; and
a matching adjustment module, for adjusting an impedance value between the antenna and the RF signal processing module according to the detection result.

8. The mobile communication device of claim 7, wherein the matching adjustment module comprises:
a matching adjustment circuit, coupled between the antenna and the RF signal processing module, for adjusting a plurality of electronic parameters according to a control signal to adjust the impedance value between the antenna and the RF signal processing module; and
a control unit, for generating the control signal according to the detection result.

9. The mobile communication device of claim 8, wherein the matching adjustment circuit comprises:
a plurality of matching units, each matching unit corresponds to a combination of electronic parameters;
a first switching unit, coupled between the antenna and the plurality of matching units, for switching a connection between the antenna and one of the plurality of matching units according to the control signal; and
a second switching unit, coupled between the plurality of matching units and the RF signal processing module, for switching a connection between one of the plurality of matching units and the RF signal processing module according to the control signal.

10. The mobile communication device of claim 8, wherein the RF signal processing module is an RF front-end circuit.
